(19) United States
(12) Patent Application Publication
(10) Pub. No.: US 2025/0201850 A1
(43) Pub. Date: Jun. 19, 2025

(54) ELECTRODE COMPRISING A COMPOSITE COATING AND ASSOCIATED MANUFACTURING METHOD

(71) Applicants: UNIVERSITE GRENOBLE ALPES, Saint Martin D'Heres (FR); CENTRE NATIONAL DE LA RECHERCHE SCIENTIFIQUE, Paris (FR)

(72) Inventors: Baptiste DAUTREPPE, Barraux (FR); Marie-Noëlle COLLOMB, Grenoble (FR); Jérôme FORTAGE, Grenoble (FR)

(21) Appl. No.: 18/856,445

(22) PCT Filed: Apr. 3, 2023
(86) PCT No.: PCT/EP2023/058707

§ 371 Date: Oct. 11, 2024

(30) Foreign Application Priority Data
Apr. 15, 2022 (FR) FR2203529

(51) Int. Cl. H01M 4/62; H01M 4/04; H01M 4/13; H01M 4/139

(52) U.S. Cl. CPC H01M 4/624; H01M 4/0442; H01M 4/0452; H01M 4/0466; H01M 4/13; H01M 4/139

(57) ABSTRACT

An electrode and the manufacturing method thereof, the electrode including a body at least partially covered with a composite coating including a polypyrrole polymer or derivatives thereof, the polymer including pyrrole monomeric units having a side chain including at least one carboxylate group. Particles of a metal oxide based on at least one metal, the amount of the at least one metal of the metal oxide being smaller than or equal to 7 mmol·cm⁻³ per carboxylate group of the pyrrole monomeric units. The electrode is improved in particular in terms of resources, environmental impact and cost, while preserving a satisfactory electrocatalytic activity.

### TECHNICAL FIELD OF THE INVENTION

The present invention relates to the field of electrodes whose surface is covered by a conductive composite polymer. It finds a particularly advantageous application in the field of electrocatalysis of chemical reactions, and more particularly electrocatalytic oxidation of water.

### PRIOR ART

For many decades, inorganic micro- and nanoparticles have been the subject of considerable attention by researchers and industry because of the improvement in catalytic performances in comparison with conventional heterogeneous catalysts and an easier separation of the target molecules in comparison with homogeneous catalysts.

Methods for manufacturing micro- and nanoparticles are numerous. Indeed, these particles may be prepared by physical, chemical or mechanical means although these methods often have a high manufacturing cost. Another limitation is their low stability during the catalysis because of the aggregation phenomenon which leads to a reduction and even to a loss of activity. The immobilisation of these particles at the surface of an electrode in order to electrochemically catalyse reactions represents an additional difficulty.

To overcome this, one approach consists in immobilizing these particles in a polymer-based coating. This approach facilitates the control of the morphology of the particles, as well as protection thereof against degradation phenomena like aggregation and corrosion. Many composite coatings exist nowadays. (Shifrina, Z. B. et al., Role of polymer structures in catalysis by transition metal and metal oxide nanoparticle composites, Chemical Reviews, 2019, 120(2), 1350-1396).

It is known in particular from the document by Boudissa, Nouredine, et al. “Synthesis of Manganese Dioxide by Mn²⁺ Complexation and Electro-Oxidation in Polypyrrole Benzoic Acid Films.” Journal of Inorganic and Organometallic Polymers and Materials, 2020, pages 1-6, an electrode coated with a composite coating of polypyrrole with the chemical formula [4-(pyrrol-1-yl methyl) benzoic acid] and metal oxide particles with the formula MnO₂. The monomer units bearing a carboxylic acid group allow stabilising the metal ions of a solution by complexation, which allows making the amount of metal ions incorporated into the film more reliable for the formation of the oxide particles by electro-oxidation.

In practice, the existing solutions are still limited for the obtainment of high-performance electrodes while reconciling the current economic, geopolitical and environmental issues. Indeed, the metals used in these metal oxide particles are rare and increasingly strategic resources. Extraction thereof is also expensive and generally polluting.

Hence, there is a need to provide an improved electrode, in particular in terms of resources, environment and cost, while preserving a satisfactory electrocatalytic activity.

The other objects, features and advantages of the present invention will become apparent upon examining the following description and the appended drawings. It should be understood that other advantages could be incorporated.

### SUMMARY OF THE INVENTION

To achieve this objective, according to a first aspect, an electrode is provided comprising a body at least partially covered by a composite coating. The composite coating comprises:
a polypyrrole polymer or derivatives thereof comprising pyrrole monomer units having a side chain, the side chain comprising at least one carboxylate group,
metal oxide particles based on at least one metal.

The coating comprises an amount of the at least one metal of the metal oxide lower than or equal to 7 mmol/cm³ per carboxylate group of the pyrrole monomer units.

Thus, the amount of metal in the coating is limited. The amount of 7 mmol/cm³ is equivalent to an amount of 245 nmol/cm². During the development of the invention, it has surprisingly been demonstrated that this amount allows obtaining a sufficient electrocatalytic activity. Thus, the electrode stands out of existing solutions using larger amounts of metal, to increase the performances of the electrodes.

As a comparative example, currently on an industrial scale, the amount of metal catalyst used in proton-exchange membrane electrolysers (commonly abbreviated as PEM, standing for Proton Exchange Membrane in English) in an acid medium is in the range of 5 to 10 mg/cm². From an economic, environmental and geopolitical perspective, the objectives announced by IRENA (International Renewable EnergyAgency) by 2050 are to pass to 0.2 mg/cm² (200 μg/cm²) or 1,025 nmol/cm² of catalysts, while preserving electrocatalytic activities allowing meeting the expectations of the market. The electrode according to this aspect exceeds these objectives with an amount of metal in the range of pg/cm² (and in particular between 3 and 10 pg/cm², i.e. between 50 and 180 nmol/cm² depending on the nature of the metal). Hence, the electrode is improved in particular in terms of resources, environment and cost, while preserving a satisfactory electrocatalytic activity.

According to a separable or combinable aspect, an electrode is provided comprising a body at least partially covered by a composite coating. The coating comprises:
a polypyrrole polymer or derivatives thereof comprising pyrrole monomer units having a side chain, the side chain comprising at least one carboxylate group,
metal oxide particles based on at least one metal.

The metal oxide particles have at least one dimension, preferably each dimension, smaller than or equal to 2 nm, preferably smaller than or equal to 1 nm.

A better distribution in the polymer film, as well as an increase in the exchange surface of the particles, are achieved. Hence, this size of metal oxide particles allows improving the electrocatalytic activity in comparison with existing solutions using particles of micrometric sizes. This size is particularly advantageous for a limited amount of metal in the coating, in order to improve the electrocatalytic activity of the electrode.

Another aspect relates to a method for manufacturing the electrode according to one of the previous two aspects and comprising:
providing the body of the electrode,
electropolymerising over the body of the electrode a polymer comprising pyrrole monomer units having a side chain, the side chain comprising at least one carboxylic acid group, so as to form a coating at least partially covering the body,
contacting the coating with a so-called “complexing” solution comprising at least one metal ion and one borate and/or phosphate buffer having a pH higher than or equal to 5.5, inducing a complexation of the at least one metal ion with at least one carboxylate group,
after contacting the coating with the complexing solution inducing the complexation of the at least one metal ion, rinsing the coating,
after rinsing the coating, electro-oxidising the complexed metal ions so as to form metal oxide particles.

During the complexation, a pH higher than or equal to 5.5 allows, on the one hand, quantitatively deprotonating the carboxylic groups into carboxylates in order to facilitate the complexation of the metal ions. Thus, the complexation of the metal ion is made more reproducible. Moreover, the phosphate and/or borate ions introduced during the complexation at this pH act as ligands at the periphery of the metal oxides generated during the electro-oxidation. These ligands limit the aggregation phenomena during the formation of the oxide particles, promoting a small size, a limited amount of metal as well as a homogeneous dispersal of the oxide particles in the coating. This further reduces the solubility of the oxide particles and improves the stability of the formed metal oxide particles.

Another aspect relates to a use of the electrode according to the first aspects or of the electrode manufactured by the method according to the previous aspect for the electrocatalytic oxidation of water.

### BRIEF DESCRIPTION OF THE FIGURES

The aims, objects, as well as the features and advantages of the invention will appear better from the detailed description of an embodiment of the latter which is illustrated by the following appended drawings, wherein:

FIG. 1 shows an electrolyser diagram comprising the electrode according to two embodiments.

FIG. 2 shows an example of the method for manufacturing the electrode.

FIGS. 3A and 3B each shows cyclovoltammograms of the activity of the coating according to several embodiments, for the oxidation of water at pH 9.2 in a 0.1M borate buffer.

FIG. 4 shows scanning electron microscopy (SEM) images of a polymer film and of the coating according to several embodiments.

FIG. 5 shows atomic force microscopy images and analyses of a polymer film and of the coating according to several embodiments.

FIGS. 6A and 6B show transmission electron microscopy (TEM) images of a polymer film and of the coating according to several embodiments.

FIG. 7 shows a grazing-incidence wide-angle X-ray scattering graph (commonly referred to by the acronym GiWAXS, standing for Grazing-Incidence Wide-Angle X-ray Scattering in English) of a polymer film and of the coating according to one embodiment.

FIGS. 8A to 8E show several ampergrams as a function of time and cyclovoltammograms of the activity of the coating over time for the oxidation of water at pH 9.2, according to several embodiments.

FIGS. 9A and 9B show scanning electron microscopy (SEM) images with energy dispersive X-ray analysis (commonly referred to as EDX, an acronym standing for Energy Dispersive X-RayAnalysis) of a coating according to one embodiment, at 0 h and 65 h.

FIGS. 10A and 10B show scanning electron microscopy images with energy dispersive X-ray analysis (commonly referred to as EDX, an acronym standing for Energy Dispersive X-RayAnalysis) of a coating according to another embodiment, at 0 h and 60 h.

FIGS. 11A and 11B respectively show an ampergram as a function of time, and a cyclovoltammogram of the activity over time, of the coating according to several embodiments.

FIGS. 12A and 12B show scanning electron microscopy images with EDX analysis of a coating according to one embodiment, at 0 h and 90 h.

The drawings are given as examples and do not limit the invention. They form schematic representations of principle intended to facilitate understanding of the invention and are not necessarily plotted to the scale of practical applications. In particular, the relative dimensions between the polymer, the metal ions, the particles and the electrode are not representative of reality.

### DETAILED DESCRIPTION OF THE INVENTION

Before starting a detailed review of embodiments of the invention, optional features are set out hereinafter, which could possibly be used in combination or alternatively.

According to one example, the metal oxide particles are based on at least two different metals. Thus, the catalytic activity of the electrode is improved. Indeed, a bimetallic oxide has significantly improved catalytic properties, in comparison with one single metal species. Furthermore, this also allows reducing the manufacturing costs when the additional metal is more abundant and less expensive, for example like iron.

According to one example, the metal of the metal oxide is a metal able to form a divalent metal ion. According to one example, the at least one metal of the metal oxide is selected from the group consisting of cobalt, nickel, iron. These metals are particularly suitable for the electrocatalytic oxidation of water. Iron is also an inexpensive metal, while allowing obtaining a good catalytic activity.

According to one example, the metal oxide particles are dispersed in the polymer, preferably homogeneously.

According to one example, the side chain of the pyrrole monomer units is linear. The presence of a linear side chain between the pyrrole unit and the carboxylate group improves the flexibility of the polymer, which influences the structure of the polymer, its porosity, in particular in comparison with a polymer whose side chain of the pyrrole units is aromatic. The diffusion of the species in the polymer (and in particular the metal ions, the electrolyte, the solvents and/or gas) is improved. This facilitates the formation of small oxide particles with a homogeneous dispersal in the composite coating.

According to one example, the linear chain is unsaturated. According to one example, the side chain is saturated.

According to one example, the side chain comprises only one carboxylate group. This allows limiting the size of the formed oxide particles, and in particular obtaining a size smaller than 1 nm.

According to one example, the at least one carboxylate group has a pKa higher than or equal to 5.5, and preferably higher than or equal to 6. For comparison, the pKa of benzoic acid in a polypyrrole film is substantially 5.2. A pKa higher than 5.5 improves the kinetics of complexation of the metals by the polymer and the stability of the obtained complex. This promotes the described amount of metal, the generation of small oxide particles, and a homogeneous dispersal of these particles in the coating.

According to one example, the side chain comprises between 2 and 10 carbon atoms, preferably 5 carbon atoms. A short carbon chain between the pyrrole unit and the carboxylate group allows influencing the size of the particles by promoting the obtainment of very small particles. Indeed, this allows limiting the steric and electronic constraints in the polymer. Conversely, a long chain increases the porosity of the film and promotes the mass transport of the reagents necessary for the electro-oxidation (transport of the ions, of the solvent for example) but also for the diffusion of the electro-generated gases (O₂ or H₂). The described range allows for a carbon chain length promoting both the generation of small oxide particles and enabling the transport of the reagents and of the gases in the coating as well as the maintenance of the metal oxides in the coating.

According to one example, the complexing solution comprises at least two different metal ions. Thus, bimetallic oxide particles are formed in the coating.

According to one example, the complexing solution comprises a phosphate or borate buffer having a pH higher than or equal to 5.5, preferably higher than or equal to 6, preferably substantially equal to 7.2. During the development of the invention, it has been demonstrated that these pH ranges further improve the stability of the formed metal oxide particles, to further promote a small size, a limited amount of metal as well as a homogeneous dispersion of the oxide particles in the coating. More particularly, in the case where the buffer is a phosphate buffer, its pH is preferably higher than or equal to 6, preferably substantially equal to 7.2.

According to one example, the complexing solution comprises a borate ion buffer having a pH higher than or equal to 7, preferably substantially equal to 7.2. The borates ions act as ligands during the nucleation of the oxide particles during the electro-oxidation. Thus, this limits their aggregation and leads to non-soluble and stable metal oxides at a pH of at least 7, and more particularly 9.2.

According to one example, when contacting the solution with the complexing solution, the temperature of the solution is maintained at 30° C. by a temperature regulation device. The complexation kinetics are temperature-dependent. Having a temperature regulation system allows overcoming the variations in complexation kinetics and thus improving the reproducibility of the complexation.

According to one example, the coating is brought into contact with the complexing solution for at least 1 hour, preferably for at least 2 hours. This allows reaching the saturation complexation of the carboxylate groups in the coating. Thus, a better repeatability of the process and a reliability of the amount of metal incorporated into the coating are obtained.

According to one example, the complexing solution has a concentration of at least one metal ion comprised between 1 and 20 mM, preferably between 1 and 16 mM, even more preferably equal to 4 mM.

According to one example, the contact of the coating with the complexing solution is done under aerobic conditions, except when the at least one metal ion is an iron (II) ion for which the contact of the coating with the solution comprising the at least one metal ion is done under anaerobic conditions in order to avoid an oxidation of the iron (II) ion into iron (III) ion.

According to one example, the electro-oxidation is an electro-oxidation by cyclic voltammetry, preferably by sweeping between 0 and 1.2 V. By this oxidation sweeping technique, the generation of the metal oxide particles is done in a progressive and mild manner while limiting the phenomena of diffusion of the metals and therefore of aggregation.

According to one example, the electro-oxidation of the metal ions is done in a solution having a pH higher than or equal to 7, preferably a pH higher than or equal to 9, preferably substantially equal to 9.2. A pH of the solution is higher than or equal to 7, and even more for a pH higher than 9, in synergy with the borate or phosphate buffer of the complexing solution, allows limiting further and preferably avoiding a dissolution of the formed metal oxides. Hence, their stability is improved. Indeed, the transformation of the carboxylate metal complexes in the form of oxides is promoted under basic conditions (pH higher than or equal to 7). During the development of the invention, it has been demonstrated that a pH higher than or equal to 9 promotes the formation by electro-oxidation of the oxide particles that precipitate in the coating 11.

According to one example, the electro-oxidation of the metal ions is done in a solution comprising a phosphate buffer, preferably having a pH higher than or equal to 7, preferably substantially equal to 7.2. According to one example, the electro-oxidation of the metal ions is done in a solution comprising a borate buffer, preferably having a pH higher than or equal to 9, preferably substantially equal to 9.2. The borate buffer during electro-oxidation allows limiting further the aggregation of the metal oxide particles, which limits the incorporated amount of metal as well as the size of the oxides.

By an element “based on” a material A, it should be understood an element comprising this material A alone or this material A and possibly other materials.

By a parameter “substantially equal to/higher than/lower than” a given value, it should be understood that this parameter is equal to/higher than/lower than the given value, within a 10% margin, or within a 5% margin, of this value.

It is specified that, in the context of the present invention, the thickness of a layer or of a coating is measured according to a direction perpendicular to the surface according to which this layer or this coating has its maximum extension. Thus, the thickness is considered according to a direction perpendicular to the main faces of the body over which the different layers and/or the coating rest. In the case of a three-dimensional element, for example a pattern of the body, the thickness of a layer extending over a sidewall of this element may be measured perpendicularly to this sidewall.

When an element is so-called “homogeneous” in another element or a volume, the amount of the element per unit volume is substantially identical in all portions of the same determined size of the other element or of the volume.

In general, a metal ion refers to an ion of a metal element of the periodic table of chemical elements.

In general, in the field of chemistry, by catalyst, it should be understood a compound increasing the speed of a chemical reaction by participating to the reaction without forming part of the reagents and of the products. In particular, a catalyst allows introducing new reaction paths, for example it does not participate directly to the reaction, but its presence facilitates breaking of the bonds, or, for example, it participates thereto and is regenerated during the reaction.

By “monomer unit”, it should be understood a molecular structure repeating in a polymer, formed from a monomer. The polymers formed from one single monomer unit are so-called homopolymers. We talk about a copolymer when at least two monomer units, of different molecular structures, form the polymer.

In the context of the present invention, the average molar masses of polymer are given by mass, i.e., equivalently, the average molar masses of polymer are mass-averaged molar masses (to be distinguished from number-averaged molar masses), and given in g/mol.

The electrode 1 and its manufacturing process 2 are now described in more detail according to several embodiments.

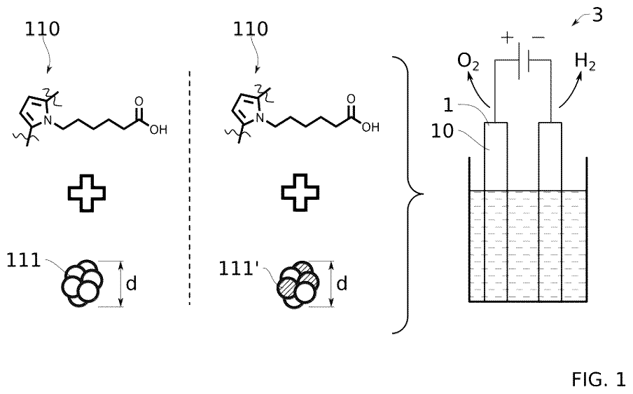

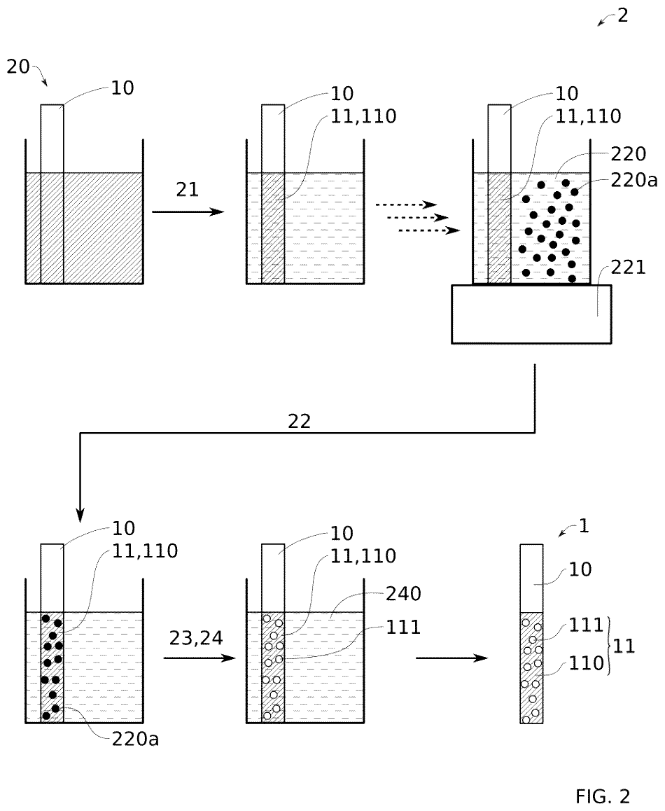

The electrode 1 is firstly described with reference to FIGS. 1 and 2. The electrode 1 comprises a body 10 over which a composite coating 11 is deposited. The composite coating 11 at least partially covers the body 10, preferably over each of its faces. The coating 11 comprises a polypyrrole polymer 110 or its derivatives, detailed later on, on which metal oxide particles 111 are absorbed, which may also be referred to as “clusters” of metal oxide. For this purpose, the polypyrrole polymer 110 is anionic and forms a matrix stabilising the particles 111. More particularly, the pyrrole monomer units have a side chain comprising at least one carboxylate group, with the chemical formula —COO⁻. As will be described in more detail later on, the carboxylate groups of the polymer 110 enable the complexation of metal ions 220a, which will be transformed afterwards into metal oxide particles 111.

The metal oxide particles 111 are intended to catalyse redox reactions. More particularly, the electrode 1 may be comprised in an electrolyser. This electrolyser may typically comprise two electrodes connected to a power supply source and allowing imposing a potential between the two electrodes. When the electrode 1 and the counter-electrode are immersed in a reaction medium and subjected to a potential, the electrode 1 can catalyse redox reactions. For example, several reactions that could be catalysed by the electrode 1, depending on the nature of the metals and of the alloys, are described hereinbelow:
oxidation of water into oxygen,
oxidation of chlorides into hypochlorite or dichlorine,
oxidation of methanol,
reduction of water into hydrogen,
reduction of carbon dioxide into hydrogen, methane, formic acid, carbon monoxide, ethylene, propylene.

The coating 11 comprising metal oxide particles 111, it should be understood from the description hereinabove that the amount of metal of the metal oxide is non-zero, and therefore strictly greater than 0 mmol/cm³.

Preferably, the coating 11 comprises an amount of metal of the metal oxide smaller than or equal to 7 mmol/cm³ (i.e. 245 nmol/cm²) per carboxylate group present on the monomer units. This amount herein corresponds to the total amount of metal in the coating 11. In the case where the coating 11 comprises multi-metal oxide particles, this amount corresponds to the sum of the amounts of each metal in the coating 11. In an equivalent manner resulting directly from the expression hereinabove, the coating comprises an amount of metal of the metal oxide smaller than or equal to A×7 mmol/cm³ with A the number of carboxylate groups of the pyrrole monomer units. Hence, one could understand that this amount of metal per unit volume applies in combination with the number of carboxylate groups. The more carboxylate groups the pyrrole monomer unit comprises, the more the capacity for fixing the metal oxide particles by the polymer increases.

As detailed later on with reference to the examples, this amount allows obtaining a sufficient electrocatalytic activity, while limiting the amount of metal in the coating 11. Hence, this electrode 1 is entirely in line with the economic and ecological objectives announced nowadays aiming to limit catalysts to a mg/cm² range (200 μg/cm²) while preserving electrocatalytic activities allowing meeting the expectations of the market. Indeed, depending on the nature of the metal, this volume amount of 7 mmol/cm³ corresponds to a mass per unit area of around 13 μg/cm² and a molar mass by weight around 245 nmol/cm²).

Furthermore, the metal oxide particles 111 preferably have at least one dimension, and preferably each dimension, smaller than or equal to 2 nm, and more preferably than 1 nm. Thus, the metal oxide particles 111 have a nanometric, and preferably a sub-nanometric, size. The very small size of the metal oxide particles 111 acting as a catalyst, dispersed and stabilised in the polymer matrix 110, allows accessing a large active surface for the catalysis. Hence, the electrocatalytic performances of the electrode 1 is enhanced.

According to one example, the metal of the metal oxide is a metal able to form a divalent metal ion. According to one example, the metal oxide of the particles 111 comprises a transition metal or an alkaline-earth metal. The nature of this metal may be selected according to the redox reaction to be catalysed. Preferably, the metal is selected from the group consisting of cobalt, nickel, iron. These metals are particularly suitable for the electrocatalytic oxidation of water. The iron is also an inexpensive metal while allowing obtaining a good catalytic activity, which allows minimising the cost of the electrode 1.

According to one example, the metal oxide of the particles 111 comprises one single metal, as illustrated in FIG. 1 with the oxide particle 111. According to an alternative example, the metal oxide of the particles 111 comprises several metals, and in particular at least two metals as illustrated in FIG. 1 with the bimetallic oxide particle 111′. During the development of the invention, and as described later on with reference to the particular examples, it has been demonstrated that a bimetallic oxide has significantly improved catalytic properties, in comparison with one single metal species. In the case where the oxide comprises several metals, one metal may consist, for example, of iron. This also allows reducing the manufacturing costs of the electrode 1, iron being more abundant and less expensive than other transition metals or alkaline-earth metals.

The polypyrrole polymer 110 or its derivatives is now described. By polypyrrole polymer 110 or its derivatives, it should be understood a polymer comprising at least in part pyrrole monomer units bearing a side chain with at least one carboxylate group per chain. The polymer 110 may be formed of only these pyrrole monomer units. Alternatively, the polymer 110 may be a copolymer comprising these pyrrole monomer units and different monomer units. Alternatively or complementarily, the polymer 110 may comprise different pyrrole monomer units bearing a side chain with at least one carboxylate group per chain.

The use of a polypyrrole polymer 110 bearing carboxylate groups to form the coating 11 allows forming a matrix maintaining the structure of the metal oxide particles 111 during the catalysis of the chemical reactions. Furthermore, the carboxylates promote self-repair mechanisms of the particles 111. This allows synergistically improving the stability of the coating 11 during use thereof.

More particularly, the side chain of the pyrrole monomer unit is attached to the pyrrole unit by the nitrogen atom. According to one example, the side chain of the pyrrole monomer unit is linear. The side chain may be saturated or have unsaturations. The presence of a linear side chain between the pyrrole unit and the carboxylate group improves the flexibility of the polymer. The diffusion of the species in the polymer (and in particular the metal ions, the electrolyte, the solvents and/or gas) is further improved. It is possible to provide for the side chain being non-linear. For example, the side chain may comprise a ring, and more particularly an aromatic ring such as benzoic acid.

Preferably, the carboxylate group of the side chain has a pKa higher than or equal to 5.5, and preferably higher than 6. During the development of the invention, it has been demonstrated that a pKa in these ranges would improve the complexation kinetics and the stability of the obtained complex. In particular, a carboxylate group of a linear side chain has a pKa higher than or equal to 5.5. Hence, besides the flexibility of the polymer, a linear side chain improves the complexation of the metal ions.

According to one example, the side chain comprises between 2 and 10 carbon atoms. This range of the lateral chain length allows obtaining a good trade-off between the generation of small-size metal oxide particles 111 and a good transport of the reagents and of the gases in the coating 11. Preferably, the side chain comprises 5 carbon atoms.

Moreover, the side chain may have one or more carboxylate group(s). According to one example, the side chain comprises one single carboxylate group. This allows limiting the amount of metal ions adsorbed in the coating 11 and therefore limiting the amount of metal in the obtained coating 11. According to one example, the side chain may comprise two carboxylate groups. This allows absorbing more metal ions in the coating 11 and forming metal oxide particles 111 with a slightly larger size, for example a particle size 111 comprised between 1 nm and 2 nm, for at least one dimension of the particle 111.

For example, the monomer unit may have one of the chemical formulas hereinbelow:

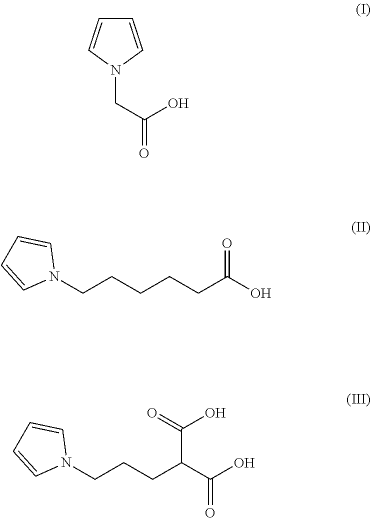

The molar mass by weight of the polymer 110 may be substantially comprised between 100 g·mol⁻¹ and 250 g·mol⁻¹, preferably between 135 g·mol⁻¹ and 215 g·mol⁻¹. The molar amount of polymer per unit area may be substantially comprised between 100 nmol/cm² and 200 nmol/cm², preferably between 125 and 160 nmol/cm². The following values for the polymer 110 have been observed for the monomer units (I) to (III) described hereinabove.

TABLE 1

| Monomer unit | (I) | (II) | (III) |
|---|---|---|---|
| Molar mass by | 139.15 | 181.24 | 211.22 |
| weight (in g · mol⁻¹) | | | |
| Molar amount of | 125 | 140 | 160 |
| polymer per unit | | | |
| area (in nmol/cm²) | | | |
| Surface mass | 17.4 | 25.4 | 33.8 |
| amount (in | | | |
| μg/cm²) | | | |

The body 10 of the electrode 1 may be based on numerous electrically-conductive materials. Several materials have been tested. For example, the body 10 of the electrode 1 may be based on glassy carbon, indium-tin oxide (commonly abbreviated as ITO, standing for Indium-Tin Oxide in English), or of carbon paper, for example a carbon paper commercialised by Toray Carbon Fibers®, denoted C_{toray} in the particular examples described later on. The body 10 may have a more or less extended outer surface depending on the uses. As example, the following surfaces S have been used:
Glassy carbon electrode with a 3 mm diameter: S=0.071 cm²
ITO electrode: S=0.8 cm² (1 cm×0.8 cm),
Carbon paper electrode: S=2.4 cm² (1.5 cm×0.8 cm×two faces).

The manufacturing method 2 is now described in more detail with reference to FIG. 2. First of all, the method 2 comprises providing the body 10 of the electrode 1. On the body 10, the coating 11 is formed by electropolymerisation of pyrrole monomers having a side chain with a carboxylic acid group, to form the polypyrrole polymer 110. After electropolymerisation of the polymer 110, the coating 11 is immersed in a complexing solution 220, so as to form complexes 22 between at least one metal ion 220a and the carboxylate groups of the polymer 110. The carboxylate groups are derived from the carboxylic acid groups after deprotonation.

Afterwards, the electrode 1 is rinsed 23 in order to eliminate the excess non-complexed metal ions 220a. After rinsing 23, the metal oxide particles 110 are formed by electro-oxidation in order to obtain the previously-described coating 11. Hence, this composite coating 11 is prepared under mild conditions through a simple and versatile electrochemical method. The electro-oxidation of these complexes results in an in situ formation of the catalysts in the form of metal oxides, in particular for electrocatalysis applications.

The method further enables the generation of metal oxide particles 111 with varied chemical composition, for example based on noble metals (such as Ir, Pt, Ru, etc.), non-noble metals (such as Ni, Co, Fe, Mn, Cu, etc.) or multi-metal oxides with a controlled proportion (NiₓFe₁₋ₓ, NiₓCo₁₋ₓ, CoₓFe₁₋ₓ, FeₓCu₁, MnₓCa₁₋ₓ, RuₓFe₁₋ₓ etc.).

Thus, the method 2 gives access to a large number of different metal oxides, each could have different electrocatalysis applications. It has also been demonstrated that the method was easily adaptable to electrodes comprising bodies with a large surface. The passage from an electrode with a surface of 0.071 cm² to more than 2.5 cm², i.e. a factor of 30, has been done while preserving the same electro-catalytic properties.

Each step is now described in more detail.

### Electropolymerisation 21 of the Polypyrrole 110

To electropolymerise 21 the polymer 110, the pyrrole monomer bearing the linear chain with the carboxylic group may be supplied or synthesised in a step of the process prior to the electropolymerisation. For example, for the previously-described three monomer units, the monomer (I) with two carbon atoms may be commercially available. The bicarboxylic monomer (Ill) may be synthesised as described in the publication J.-C. Moutet, A. Zouaoui, Electrochimica Acta 2001, 46, 4035-4041. The monomer (II) may be synthesised as described hereinbelow.

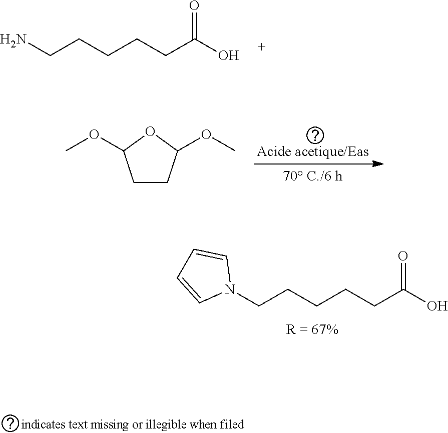

The electropolymerisation 21 of the polypyrrole 110 may be carried out electrochemically (and in particular by chronoamperometry), preferably in an anaerobic environment. For example, the electropolymerisation 21 is carried out in an acetonitrile solution comprising the pyrrole monomer to be polymerised, in which the body 10 of the electrode 1 is immersed.

For example, the electropolymerisation 21 is carried out at a controlled potential of +0.85 V vs Ag/AgNO₃ for a charge of 0.056 C/cm² in an acetonitrile solution (CH₃CN+0.05 M of [Bu₄N]ClO₄ in electrolyte) containing 4 mM of the pyrrole monomer.

Complexation 22 of the metal ions 220a Once the body 10 of the electrode 1 is at least partially coated with the polymer 110, the body 10 is soaked in a complexing solution 220 containing metal cations 220a, preferably in the Mz⁺ form, in order to enable complexations thereof by the carboxylate functions of the polymer 110. Preferably, this solution 220 is an aqueous solution. This contact of the coating 11 with the complexing solution 220 induces the complexation of the metal ions 220a. In an equivalent manner, this step is referred to as the complexation 22 of the metal ions.

The carboxylate functions have a good affinity for numerous metal cations, or alkaline-earth metal cations. Their presence in the electropolymerised polypyrrole 110 coating 11 at the surface of the body 10 will enable the incorporation and the stabilisation of a wide variety of metal ions 220a (for example Ni, Co, Fe, Cu, Mn, etc.) but also the simultaneous incorporation of several cations in controlled proportions (for example NiₓFe₁₋ₓ, CoₓFe₁₋ₓ, NiₓCo₁₋ₓ, etc.) through a simple complexation between the metal ion and the carboxylate.

In order to improve the repeatability of the process and make the amount of complexed metal ions 220a as well as the subsequent formation of the metal oxide particles 110 more reliable, the complexation conditions are done in a buffer medium at a controlled pH to concomitantly enable the deprotonation of the carboxylate functions borne by the polymer film and the solubility of the used metal salts.

For this purpose, the complexing solution 220 comprises a borate and/or phosphate buffer having a pH higher than or equal to 5.5. Preferably, the pH of the buffer is higher than or equal to the pKa of the carboxylic acid group of the monomer unit, in order to deprotonate it into a carboxylate and induce the complexation of the metal ions 220a. The phosphate and/or borate ions introduced during complexation at this pH also act as ligands at the periphery of the metal oxides generated during the electro-oxidation 24. These ligands limit the phenomena of aggregation during the formation of the oxide particles 111, promoting a small size, a limited amount of metal as well as a homogeneous dispersion of the oxide particles 111 in the coating 11. This further reduces the solubility of the oxide particles 111 which might be soluble otherwise at a pH higher than 5.5, and improves their stability.

According to one example, the pH of the complexing solution 220 is higher than 6, for example substantially equal to 7.2. This pH range enables a quantitative deprotonation of the carboxylate groups and facilitates the complexation of the metal ions 220a.

According to a preferred example, the complexing solution comprises a borate buffer, still more preferably having a pH higher than or equal to 6, preferably substantially equal to 7.2. Note that the pH of the complexing and/or electro-oxidation solution may also be adapted according to the nature of the metal salts so that the salts are soluble under the pH conditions. During the development of the invention, it has been demonstrated that a borate buffer at this pH was particularly suitable as a ligand at the periphery of the metal oxides generated during the electro-oxidation.

According to one example, the complexing solution 220 comprises at least two different metal ions 220a. Thus, multi-metal oxide particles 111 are formed in the coating 11, as described before. The metal ions in the complexing solution are selected according to the oxide to be obtained. According to an alternative example, the complexing solution 220 may comprise one single type of metal ion 220a, to obtain particles 111 of an oxide of one single metal.

According to one example, the complexing solution 220 has a total concentration of metal ions comprised between 1 and 20 mM (1 mM=10³ mol/L), preferably between 1 and 16 mM, and even more preferably equal to 4 mM. During the development of the invention, a total concentration of 4 mM have given the best results in terms of electrocatalytic performances of the electrode. In the case where the complexing solution 220 comprises several metal ions, the sum of their respective concentration gives the total concentration specified hereinabove. This total concentration enables a saturation complexation of the metal ions 220a by the carboxylate groups of the polymer 110, while avoiding overloading the complexing solution 220 with metal ions 220a. Thus, the cost and the environmental impact of the process 2 are limited.

In the case where the complexing solution 220 comprises several metal ions, the respective concentration of each metal ion may be adjusted so as to make the relative proportions of metal in the formed oxide vary, and in particular for a total concentration of 4 mM.

Preferably, during complexation 22, the experimental conditions are controlled so as to promote a reproducible complexation of the metal ions 220a.

For this purpose, the temperature of the complexing solution 220a may be controlled at a set temperature. In particular, the temperature of the complexing solution 220 is preferably maintained at a temperature comprised between 2° and 35° C., and preferably substantially equal to 30° C., by a temperature regulation device 221 as illustrated, for example, in FIG. 2. This temperature range, and in particular the value of 30° C., allows improving the complexation kinetics while allowing preserving the integrity of the compounds of the coating 11. Note that the complexing solution 220 may be at room temperature, i.e. 20° C.

Moreover, the coating 11 may be immersed in the complexing solution 220 for at least 1 hour, preferably for at least 2 hours, in order to reach the saturation complexation of the metal ions 220a by the carboxylate groups of the polymer 110.

According to one example, the complexation 22 is done under aerobic conditions. This allows simplifying this step of the process 2. In the case where the complexing solution 220 comprises an iron (II) ion, the complexation 22 is preferably done under anaerobic conditions in order to avoid an oxidation of the iron (II) ion into iron (III) ion.

For example, the complexing solution 220 is an aqueous solution comprising 0.1 mol/L of boric acid (H₃BO₃) at pH 7.2 with a concentration of cationic metal ion M²⁺ substantially equal to 4 mM (and in particular for Ni²⁺, CO²⁺, Fe²⁺).

### Rinsing 23

After complexation 22, the electrode 1, and more particularly the coating 11, is rinsed in order to eliminate the non-complexed metal ions 220a. This allows limiting the amount of metal incorporated into the coating 11 and making it more reliable.

For this purpose, the electrode 1 may be rinsed with water, and more particularly with water, preferably in an aqueous solution having a pH higher than or equal to 5.5, in order to avoid a protonation of the carboxylates. According to one example, the pH of the solution used during rinsing 23 is higher than or equal to 6, preferably substantially equal to 7.2. The pH may be identical to the pH of the complexing solution 220. The aqueous rinsing solution may comprise a borate or phosphate buffer, for example the same buffer as that one used in the complexing solution 220.

In this step, the modified electrodes 1 may be kept for several weeks in a humid atmosphere, which is a real advantage with regards to the manufacturing process.

### Electro-Oxidation 24 and Formation of the Metal Oxide Particles 111

After rinsing 21, the electrode 1 is subjected to an electro-oxidation 24 so as to form the metal oxide particles 111 from the complexed metal ions 220a.

For this purpose, the electrode 1 is at least partially immersed in an electrically-conductive aqueous solution 240, so as to immerse the coating 11. The solution 240 may have a pH higher than or equal to 5.5. Preferably, the solution 240 has a pH higher than or equal to 7, i.e. a basic pH. Thus, a protonation of the carboxylates is avoided. Preferably, the solution 240 has a pH higher than 9, and preferably substantially equal to 9.2. A pH higher than or equal to 9 allows promoting the kinetics of formation of the metal oxide particles 111, in comparison with a lower pH for which part of the metal ions 220a could remain in an ionic form.

Preferably, the solution 240 is free of metal ions, in order not to add ions into the coating and thus limit the incorporated amount of metal as well as the size of the particles 111.

The solution 240 may comprise a borate buffer, preferably with a pH substantially equal to 9.2. Thus, the borate ions stabilise the metal oxide particles 111 by acting as a ligand, and avoids dissolution thereof. Note that phosphate (preferably at pH 7) or acetate (preferably at pH 5.5) buffers may alternatively be used, in particular depending on the nature of the metal ions 220a. For example, an aqueous borate solution at 0.1 mol/L H₃BO₃, 0.1 mol/L Na₂SO₄ at pH 9.2 and free of any metal salt is used.

Preferably, the electro-oxidation is done by cyclic voltammetry (commonly abbreviated CV, standing for Cyclic Voltammetry in English). By this technique, the generation of the metal oxide particles is done in a progressive and “mild” manner while limiting the diffusion of the metal ions 220a. The fact that the metal ions 220a diffuse less in the polymer 110 during oxidation thereof, considerably limits aggregation thereof and therefore the size of the obtained particles 111. For this purpose, potentials from 0 to 1.2 V (vs Ag/AgCl) may be swept. Potentials from 1 to 1.2 V (vs Ag/AgCl) may be cyclically swept. Sweeping beyond 1 V allows electro-generating the oxide particles in the polymer film, in particular for the metals Co, Ni and Fe. Note that this potential range is particularly suitable for a solution pH of 9.2. Nonetheless, this sweeping range may vary depending on the pH conditions.

It should be noted that, hereinafter, the electro-oxidations are carried out by sweeping over a range from 0 to 1.2 V in order to be able to monitor the evolution of the redox signature of the Ni^{II}/Ni^{III} and Co^{II}/Co^{III} pairs for potentials lower than 1 V.

According to one example, between 30 and 200 sweeping cycles have been used for the electro-generation of the oxide particles 111. Note that this number could vary depending on several parameters such as the nature of the metal, of the electrode support, the pH, for example. The electro-oxidation may be carried out over a sufficient number of cycles such that there is no longer any variation in the intensity of both the oxide signal (if present) and of the catalytic current.

### Particular Embodiments

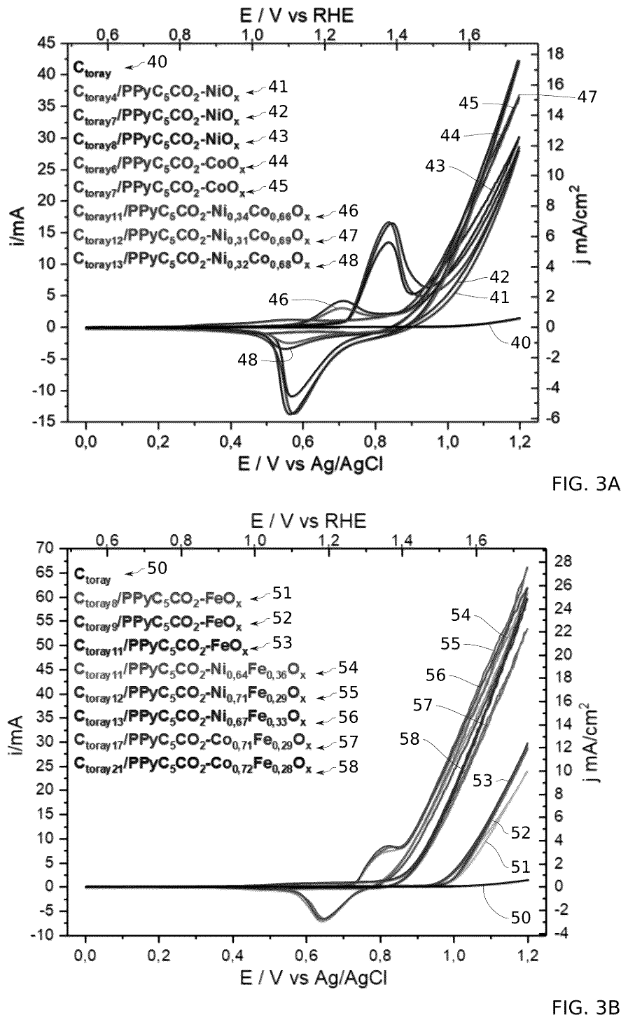

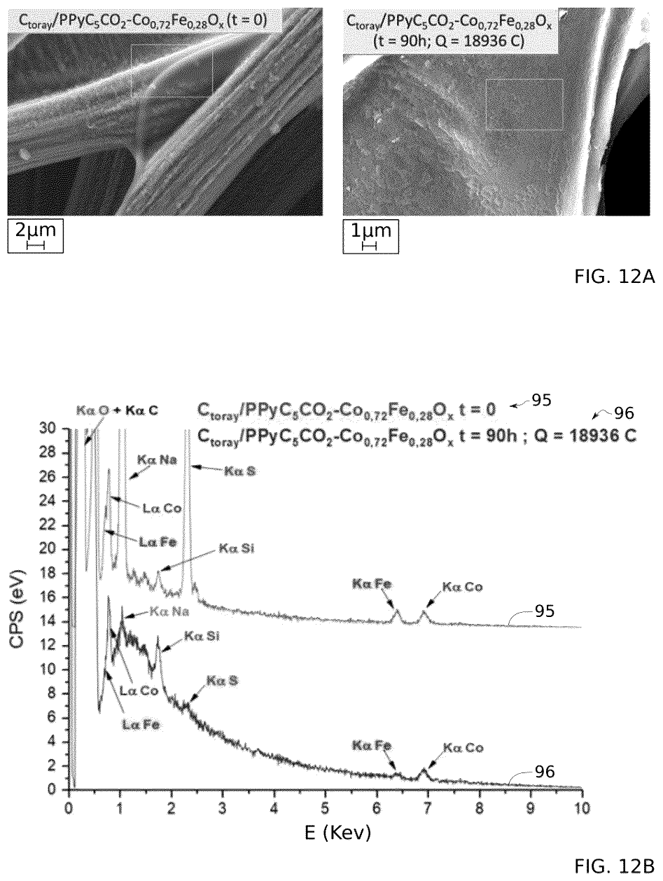

Particular examples as well as characterisation thereof are now described with reference to FIGS. 3A to 12B.

The table hereinbelow describes examples of metals of the metal oxide of the particles 111 as well as the volume molar amount incorporated in the coating 11.

TABLE 2

| | | Ratio of the amount of |
|---|---|---|
| | Metal amount (Γ_{M}, in | metals to the amount of |
| Metal | mmol/(cm³ · COOH)) | carboxylate (Γ_{M}/Γ_{COOH}) |
| Nickel | 1.26 | 0.28 |
| Cobalt | 2.08 | 0.46 |
| Nickel-cobalt | 2.07 | 0.46 |
| Iron | 3.83 | 0.85 |
| Nickel-iron | 2.27 | 0.50 |
| Cobalt-iron | 2.14 | 0.47 |

In the performed tests, a maximum amount of metal of 190 nmol/cm² in total in the coating 11, and for a mass of polypyrrole of 25.4 μg/cm² (140 nmol/cm²) has been incorporated, with one single carboxylate group per monomer unit.

Electrodes 1 have been manufactured according to the method 2 and the tables 2 and 3 hereinbelow summarise the composition of the complexing solution 220 and their measured characteristics. Any deviations are due to an experimental variation. All of the measurements are carried out in the same manner on coatings manufactured under the same conditions (except for the parameters varying as indicated from one example to another).

To manufacture these electrodes, the following experimental conditions have been used:
electropolymerising a monomer according to the previously-described formula (II), abbreviated hereafter PpyC₅CO₂H and PpyC₅CO₂-M after complexation of the metal M, carried out at a controlled potential of +0.85 V vs Ag/AgNO₃ for a charge of 0.056 C/cm² in a solution of acetonitrile (CH₃CN+0.05 M of [Bu₄N]ClO₄ in electrolyte) containing 4 mM of pyrrole monomer, on a carbon paper hereinafter referred to as Ctoray. Note that glossy carbon and ITO electrodes have also been tested, as described before.
complexing in the complexing solution 220 indicated in the tables hereinbelow under the indicated conditions,
rinsing the electrode 1 in an aqueous borate buffer solution 0.1 mol/l at pH 7.2,
electro-oxidation by CV in an aqueous borate solution at 0.1 mol/L H₃BO₃, 0.1 mol/L Na₂SO₄ at pH 9.2 and free of metal salts, by sweeping between 0 and +1.2 V vs Ag/AgCl.

The amounts of metal incorporated into the coating 11 have been measured by inductively-coupled plasma-atomic emission spectroscopy (commonly referred to as ICP-AES, standing for Inductively Coupled Plasma-Atomic Emission Spectroscopy in English). Note that other measurement methods would allow reaching the same result.

The ICP-AES assay is described hereinafter according to one example. The coating 11 is first dissolved in an aqueous nitric acid solution (HNO₃, 1 mol/L). For this purpose, the C_{toray} electrodes modified by the coatings are placed in 2 mL of the aqueous nitric acid solution at 1 mol/L, contained in analysis tubes made of metal-free plastic. The analysis tubes made of metal-free plastic allow not distorting the amount of metal measured in comparison with tubes made of other materials, for example glass, which could lead to an overevaluation of the amount of metal. Preferably, these tubes consist of ICP analysis tubes. The dissolution of the coating 11 is carried out after at least 4 h of soaking in these analysis tubes, interrupted by a passage in an ultrasonic bath every 2 h for 1 min.

After dissolution of the coating, a volume of 4 mL of ultrapure water is added to each analysis tube to obtain a solution with a total volume of 6 mL. The non-dissolved C_{toray} electrode support is removed from the analysis tube to enable the automated assay by ICP-AES.

Afterwards, the ICP-AES apparatus is calibrated. The used equipment is an ICP-AES Varian 720ES spectrometer with a detection limit of 1-20 ppb (ppb abbreviation of part-per-billion, equivalent to μg·L¹) and a quantification limit in the range of 1-50 ppb.

The concentrations (in mg/L) of the different metals present in the analysis solution have been obtained using an external calibration curve made based on aqueous solutions mixing Ni(NO₃)₂, Co(NO₃)₂, Fe(NO₃)₃ and Ca(CO₃) (ICP standard samples, Roth, 99.995%) over a concentration window ranging from 0.001 mg/L to 1 mg/L. Each metal element has characteristic emission lines allowing assaying thereof, by integration. In our studies, we have selected the following emission lines: (λ_{Ni}=216 nm, λ_{Co}=230 nm, λ_{Fe}=234 nm, λ_{Ca}=317 nm).

All of the metal elements originating from a dissolved coating are assayed simultaneously by integration over their respective wavelengths. 3 replicas are made for each metal at their respective wavelengths, allowing defining, thanks to the calibration curve, an average concentration value (in mg/L) in the solution resulting from the dissolution of the coating of an electrode.

The same procedure is carried out for each solution resulting from the dissolution of the coating of a different electrode (results of the table in mg/L).
The amounts in nmol/cm² and μg/cm² are calculated from the surface of the C_{toray} electrode (S_{geometric}, in these examples equal to 2.4 cm²). The current densities j, the mass activities, the TOF (Turnover Frequency) and the incorporation rates (Γ_{MC}/Γ_{COOH}) are calculated from the currents measured at a potential of 1.2 V vs Ag/AgCl, namely an overvoltage of 0.71 V by cyclic voltammetry in an aqueous solution of 0.1 M borate, pH 9.2 at 30° C.

TABLE 3

| | | | | | | | | |
|---|---|---|---|---|---|---|---|---|
| | | | | | Current | Mass | | |
| | Metal | Metal | Metal | | density J | activity | TOF | |
| Electrode C_{toray} | amount in | amount in | amount in | Proportions | (mA · cm⁻²) | (A · mg) | s⁻¹ | Γ_{M}/ |
| (numerical ref.) | mg/L | nmol · cm⁻² | μg· cm⁻² | % Co/% Ni | at 0.71 V | at 0.71 V | 0.71 V | Γ_{COOH} |

Complexing solution (0.1M H₃BO₃, pH 7.2, 30° C., 2 h) with 4 mM NiSO₄

| | | | | | | | |
|---|---|---|---|---|---|---|---|
| C_{toray}/ | 1.31 | 55.65 | 3.28 | 11.6 | 3.54 | 0.54 | 0.31 |
| PPyC₅CO₂—NiOₓ (41) | | | | | | | |
| C_{toray}/ | 0.92 | 39.18 | 2.31 | 11.91 | 5.16 | 0.79 | 0.22 |
| PPyC₅CO₂—NiOₓ (42) | | | | | | | |
| C_{toray}/ | 1.33 | 56.44 | 3.33 | 12.53 | 3.77 | 0.58 | 0.31 |
| PPyC₅CO₂—NiOₓ (43) | | | | | | | |
| Average | 1.189 | 50.42 | 2.97 | 12.01 | 4.15 | 0.63 | 0.28 |
| Standard deviation | 0.230 | 9.75 | 0.57 | 0.47 | 0.88 | 0.13 | 0.05 |

Complexing solution 0.1M H₃BO₃, pH 7.2, 30° C., 2 h) with 4 mM CoSO₄

| | | | | | | | |
|---|---|---|---|---|---|---|---|
| C_{toray}/ | 1.90 | 80.41 | 4.74 | 15.26 | 3.22 | 0.49 | 0.45 |
| PPyC₅CO₂—CoOₓ (44) | | | | | | | |
| C_{toray}/ | 2.03 | 86.20 | 5.08 | 15.06 | 2.96 | 0.45 | 0.48 |
| PPyC₅CO₂—CoOₓ (45) | | | | | | | |
| Average | 1.964 | 83.31 | 4.91 | 15.16 | 3.09 | 0.47 | 0.46 |
| Standard deviation | 0.097 | 4.09 | 0.24 | 0.14 | 0.18 | 0.03 | 0.02 |

Complexing solution (0.1M H₃BO₃, pH 7.2, 30° C., 2 h) with 2 mM NiSO₄ and 2 mM CoSO₄

| | | Metal | Metal | | | | | |
|---|---|---|---|---|---|---|---|---|
| | Metal | amount in | amount in | | Current | Mass | | |
| | amount | nmol · cm⁻² | μg · cm⁻² | | density J | activity | TOF | |
| Electrode C_{toray} | in mg/L | (Co/Ni and | (Co/Ni and | Proportions | (mA · cm⁻²) | (A · mg) | s⁻¹ | Γ_{M}/ |
| (numerical ref.) | (Co/Ni) | (Co + Ni)) | (Co + Ni)) | % Co/% Ni | at 0.71 V | at 0.71 V | 0.71 V | Γ_{COOH} |
| C_{toray}/ | 1.32/0.68 | 55.80/28.91 | 3.29/1.70 | 66/34 | 17.61 | 3.53 | 0.54 | 0.47 |
| PPyC₅CO₂—Co_{0.7}Ni_{0.3}Oₓ (46) | | (84.71) | (4.99) | | | | | |
| C_{toray}/ | 1.30/0.59 | 55.04/24.92 | 3.24/1.47 | 69/31 | 15.37 | 3.26 | 0.50 | 0.44 |
| PPyC₅CO₂—Co_{0.4}Ni_{0.5}Oₓ (47) | | (79.96) | (4.71) | | | | | |
| C_{toray}/ | 1.35/0.63 | 57.07/26.70 | 3.36/1.57 | 68/32 | 17.5 | 3.54 | 0.54 | 0.47 |
| PPyC₅CO₂—Co_{0.5}Ni_{0.4}Oₓ (48) | | (83.77) | (4.94) | | | | | |
| Average | 1.32/0.63 | 55.97/26.85 | 3.30/1.58 | 68/32 | 16.83 | 3.44 | 0.53 | 0.46 |
| | | (82.81) | (4.88) | | | | | |
| Standard deviation | 0.02/0.05 | 1.03/2.00 | 0.06/0.12 | | 1.26 | 0.16 | 0.02 | 0.01 |

TABLE 4

| | | | | | | | | |
|---|---|---|---|---|---|---|---|---|
| Electrode | | | | | Current | Mass | | |
| C_{toray} | Metal | Metal | Metal | Proportions | density J | activity | TOF | |
| (numerical | amount | amount in | amount in | % Co/% Ni/ | (mA · cm⁻²) | (A · mg) at | s⁻¹ | ┌M/ |
| ref.) | in mg/L | nmol · cm⁻² | μg · cm⁻² | % Fe | at 0.71 V | 0.71 V | 0.71 V | ┌COOH |

Complexing solution (0.1M H₃BO₃, pH 7.2, 30° C., 2 h) with 4 mM FeSO₄

| | | | | | | | |
|---|---|---|---|---|---|---|---|
| C_{toray}/ | 4.02 | 179.97 | 10.05 | 12.11 | 1.20 | 0.17 | 1.00 |
| PPyC₅CO₂—FeOₓ | | | | | | | |
| (51) | | | | | | | |
| C_{toray}/ | 3.65 | 163.27 | 9.12 | 11.87 | 1.30 | 0.19 | 0.91 |
| PPyC₅CO₂—FeOₓ | | | | | | | |
| (52) | | | | | | | |
| C_{toray}/ | 2.60 | 116.33 | 6.50 | 12.42 | 1.91 | 0.28 | 0.65 |
| PPyC₅CO₂—FeOₓ | | | | | | | |
| (53) | | | | | | | |
| Average | 3.422 | 153.19 | 8.56 | 12.13 | 1.47 | 0.21 | 0.85 |
| Standard | 0.737 | 32.99 | 1.84 | 0.28 | 0.38 | 0.06 | 0.18 |
| deviation | | | | | | | |

| | | | | | | | | |
|---|---|---|---|---|---|---|---|---|
| | | Metal | Metal | | | | | |
| Electrode | Metal | amount in | amount in | | Current | Mass | | |
| C_{toray} | amount | nmol · cm⁻² | μg · cm⁻² | | density J | activity | TOF | |
| (numerical | in mg/L | (Ni/Fe and | (Ni/Fe and | Proportions | (mA · cm⁻²) | (A · mg) at | s⁻¹ | ┌M/ |
| ref.) | (Ni/Fe) | (Ni + Fe)) | (Ni + Fe)) | % Ni/% Fe | at 0.71 V | 0.71 V | 0.71 V | ┌COOH |

Complexing solution (0.1M H₃BO₃, pH 7.2, 30° C., 2 h) with 3 mM NiSO4 1 mM FeSO4

| | | | | | | | | |
|---|---|---|---|---|---|---|---|---|
| C_{toray}/ | 1.40/0.79 | 59.23/35.21 | 3.49/1.97 | 64/36 | 25.37 | 4.93 | 0.78 | 0.52 |
| PPyC₅CO₂—Ni_{0.64}Fe_{0.36}Oₓ | | (94.43) | (5.46) | | | | | |
| (54) | | | | | | | | |
| C_{toray}/ | 1.42/0.59 | 60.29/26.34 | 3.55/1.47 | 71/29 | 27.63 | 5.50 | 0.83 | 0.48 |
| PPyC₅CO₂—Ni_{0.71}Fe_{0.29}Oₓ | | (86.63) | (5.02) | | | | | |
| (55) | | | | | | | | |
| C_{toray}/ | 1.41/0.71 | 59.72/31.65 | 3.52/1.77 | 67/33 | 25.74 | 4.87 | 0.73 | 0.51 |
| PPyC₅CO₂—Ni_{0.67}Fe_{0.33}Oₓ | | (91.37) | (5.29) | | | | | |
| (56) | | | | | | | | |
| Average | 1.41/0.69 | 59.74/31.07 | 3.52/1.74 | 67/33 | 26.25 | 5.10 | 0.78 | 0.50 |
| | | (90.81) | (5.26) | | | | | |
| Standard | 0.01/0.10 | 0.53/4.46 | 0.03/0.25 | | 1.21 | 0.35 | 0.05 | 0.02 |
| deviation | | (3.93) | (0.22) | | | | | |

| | | | | | | | | |
|---|---|---|---|---|---|---|---|---|
| | | Metal | Metal | | | | | |
| Electrode | Metal | amount in | amount in | | Current | Mass | | |
| C_{toray} | amount | nmol · cm⁻² | μg · cm⁻² | | density J | activity | TOF | |
| (numerical | in mg/L | (Co/Fe and | (Co/Fe and | Proportions | (mA · cm⁻²) | (A · mg) at | s⁻¹ | ┌M/ |
| ref.) | (Co/Fe) | (Co + Fe)) | (Co + Fe)) | % Co/% Fe | at 0.71 V | 0.71 V | 0.71 V | ┌COOH |

Complexing solution (0.1M H₃BO₃, pH 7.2, 30° C., 2 h) with 3 mM CoSO₄ 1 mM FeSO₄

| | | | | | | | | |
|---|---|---|---|---|---|---|---|---|
| C_{toray}/ | 1.23/0.49 | 52.33/22.16 | 3.08/1.23 | 71/29 | 22.26 | 5.15 | 0.77 | 0.41 |
| PPyC₅CO₂—Co_{0.71}Fe_{0.29}Oₓ | | (74.43) | (4.32) | | | | | |
| (57) | | | | | | | | |
| C_{toray}/ | 1.60/0.62 | 68.02/27.75 | 4.04/1.55 | 72/28 | 24.8 | 4.43 | 0.67 | 0.54 |
| PPyC₅CO₂—Co_{0.72}Fe_{0.28}Oₓ | | (96.38) | (5.59) | | | | | |
| (58) | | | | | | | | |
| Average | 1.43/0.56 | 60.48/24.93 | 3.56/1.39 | 72/28 | 23.53 | 4.79 | 0.72 | 0.47 |
| | | (85.40) | (4.96) | | | | | |
| Standard | 0.27/0.09 | 11.52/4.00 | 0.68/0.22 | | 1.80 | 0.51 | 0.08 | 0.09 |
| deviation | | (15.52) | (0.90) | | | | | |

During the electropolymerisation, the formation of particles 111 of nickel oxide NiOₓ has been observed by the progressive apparition of an irreversible system, characteristic of the electroactivity of NiOₓ (the redox pair Ni^{II}(OH)₂/Ni^{III}(O)(OH) with an anodic peak and a cathodic peak located respectively at +0.78 and +0.58 V vs Ag/AgCl. The apparition of NiOₓ is associated with a catalytic current above +0.95 V whose the intensity progressively increases with the number of sweeps. This process is attributed to the catalytic oxidation of water into O₂ by NiOₓ, concomitant with the formation of the species NiOₓ in two preferred phases β-Ni^{III}(O)(OH) and/or γ-Ni^{IV}(O)(OH).

After about thirty, and possibly fifty, cycles, there is no longer any significant increase in the redox process Ni^{II}(OH)₂/Ni^{III}(O)(OH) as well as the associated catalytic current suggesting that all of the Ni^{II} complexes initially present in the film have been transformed into NiOₓ.

Note that the oxidation and the overoxidation of polypyrrole 110 could be observed during the first sweep respectively by means of two wide anode processes around +0.6 and +1.0 V. Consequently, after the first sweep, the conductivity of the polypyrrole 110 is reduced, and even destroyed, because of overoxidation thereof. Thus, after electropolymerisation, the polymer 110 acts primarily as a matrix and the conductivity of the composite coating 11 is ensured by the dispersed metal oxide particles 111.

The formation of clusters of cobalt oxides, CoOₓ, iron, FeOₓ, as well as that of bimetallic clusters Ni_{y}Co_{1-y}Oₓ, Co_{y}Fe_{1-y}Oₓ, Ni_{y}Co_{1-y}Oₓ has been carried out according to the same procedure.

The formation of the CoOₓ particles was more difficult to observe than in the case of NiOₓ because the Co^{II}(OH)₂/Co^{III}(O)(OH) redox process has a lower intensity, with an anodic peak and a cathodic peak respectively located at +0.58 and +0.54 V. The modified glassy carbon electrodes (Cᵥᵢₜ) Cᵥᵢₜ/PPyC₅CO₂—CoOₓ has superior performances in terms of current density which reaches 16 mA·cm² at 1.2 V, after about thirty cycles from 0 to 1.2 V.

Unlike the nickel oxide, the iron oxide does not have a redox system; only a catalytic current is observed.

As regards monometallic oxides, the optimum concentration of metal salts of the observed immersion solution was 4 mM irrespective of the metal cation, Ni²⁺, CO²⁺ or Fe²⁺□. Note that, in each case, the concentrations of 1, 2, 4 and 16 mM have been tested and the corresponding ICP-AES measurements have allowed defining incorporated values for 4 mM, considered as optimum conditions of 2.97, 4.91 and 8.56 μg/cm² respectively.

FIGS. 3A and 3B illustrate the electrocatalytic activity of the coatings 11 for the oxidation of water at pH 9.2 (the numerical references for each curve are indicated in Tables 2 and 3 hereinabove, 40 and 50 referring to an uncoated carbon paper electrode denoted C_{toray}). The presence of the oxidation and reduction peaks is characteristic of the metal oxides according to the nature of the metal.

In tables 2 and 3 as well as in FIGS. 3A and 3B, the current density j (mA·cm²) defines the pure performance of the coating with respect to the water oxidation reaction at an overvoltage of 0.71 V (equivalent to a potential of 1.2 V vs Ag/AgCl in the figures). The mass activity (A/mg) defines the performance as a function of the amount of metal oxide catalysts and of the applied overvoltage. The Γ_{M}/Γ_{COOH} ratio allowing defining the amount of metal as a function of the amount of carboxylate group.

As regards the oxides of iron and of mixed metals, in FIG. 3B, the appearance of the signal, corresponding to the electroactivity of the oxide, varies according to the nature of the metals and of their respective proportions. Even higher densities of catalytic currents have been obtained with the bimetallic oxides reaching 20-28 mA/cm² at 1.2 V.

Electrochemical characterisations have also been carried out to demonstrate the effectiveness of these materials at different temperatures, not illustrated herein. It has been observed that the intrinsic catalytic activity (i.e. the reaction kinetics) of these materials is almost not influenced by the temperature although the increase in temperature still allows reaching even higher currents (up to 40 mA·cm⁻² in the case of mixed oxides at 50° C.

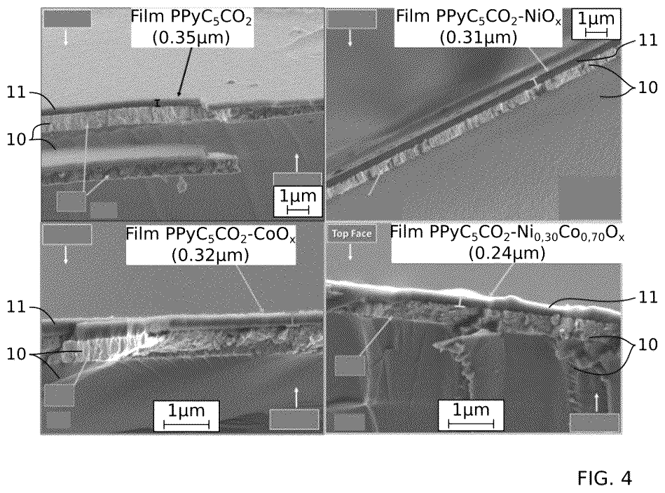

As illustrated in FIG. 4, it has been possible to determine the thickness of a coating with no oxide particles (PPyC₅CO²⁻□□) equivalent to an amount of carboxylate of 140 nmol/cm² by carrying out a deposition over a planar ITO surface 10. The measured thickness value is 350 nm (0.35 μm). After incorporation of the metal oxide particles 111, no particle could be observed whether on the coating 11 or at the interface with the electrode 1 body 10. The fact of observing no increase in the thickness of the coating after generation of the particles 111 is in line with small particles 111 smaller than one nm which do not influence the physical characteristics of the coating 11.

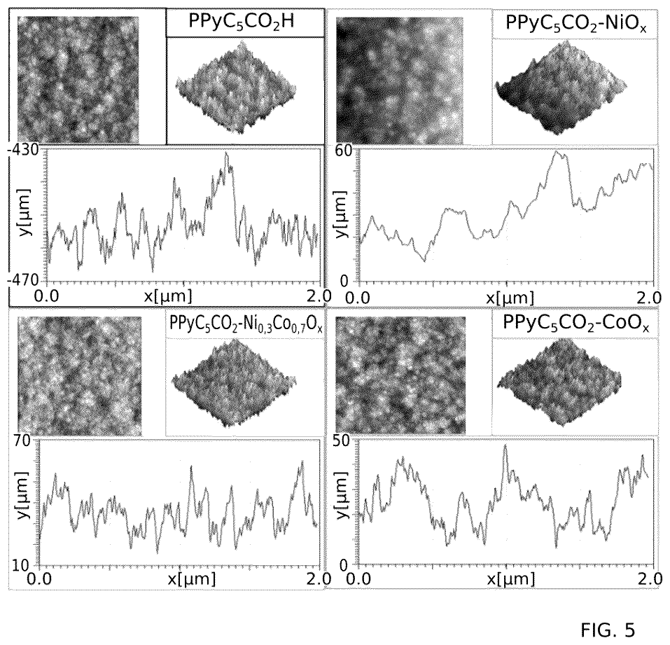

By atomic force microscopy (abbreviated AFM, standing for Atomic Force Microscopy in English), as illustrated in FIG. 5, after incorporation of the metal oxide particles 111, no particle could be observed on the coating 11. Observing average surface roughness (abbreviated RMS in the figure, standing for Rough Mean Square in English) of the same order of magnitude for a coating PPyC₅CO²H without or with metal oxide particles 111 will also be in line with small particles that do not influence the physical characteristics of the coating 11.

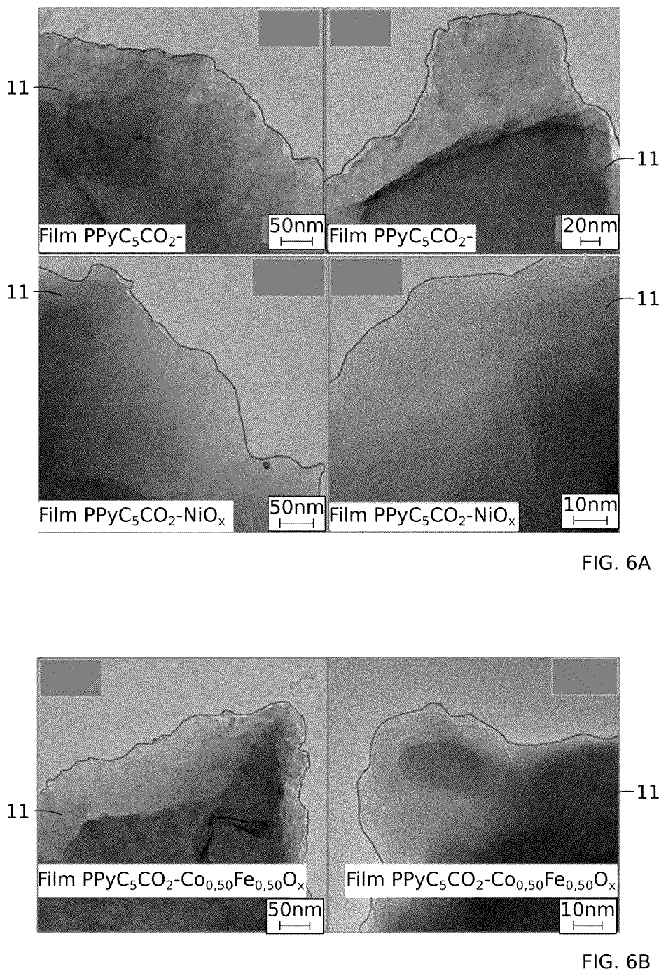

As illustrated by FIGS. 6A and 6B, the coatings 11 have been observed by transmission electron microscopy. Herein again, after incorporation of the metal oxide particles 111, no particle is observed in the coating 11 on the observed scales. Observing no particles 111 by transmission electron microscopy despite the presence of metals confirmed by electrochemistry and ICP-AES measurement is in line with particles having a size smaller than 1 nm outside the detection limits of the techniques.

The performed measurements indicate that the in situ electro-generation of oxides from the carboxylate complexes allows avoiding the aggregation phenomena and thus reaching nanoparticle sizes close to those of a cluster (s 1 nm) composed of a small number of metal entities in accordance with a “bottom-up” nucleation method.

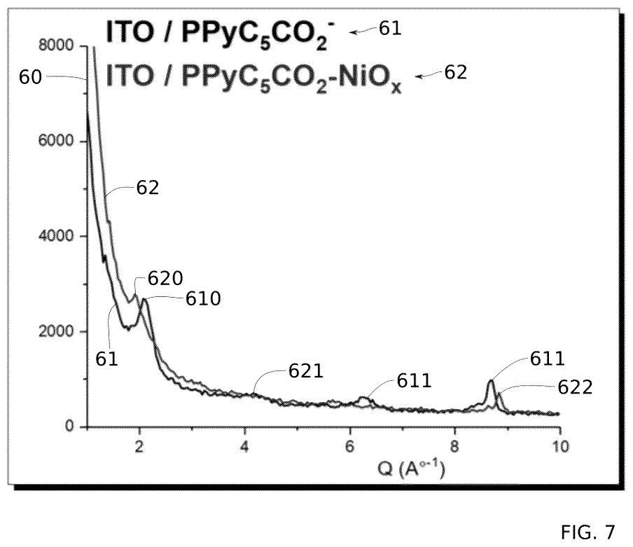

To support this, complementary measurements of X-ray diffraction by GiWAXS have been carried out in an effort to know the nature of these clusters (crystalline or amorphous) as well as their spatial distributions. The results obtained for the ITO/PPyC₅CO₂—NiOₓ composite coating 11 are summarised in FIG. 7 which is a grazing-incidence wide-angle X-ray scattering graph representing the intensity 60 as a function of the diffusion vector. It is possible to observe the presence of a diffraction peak 610 around 2 Å⁻¹, attributed to the spatial organisation of the polypyrrole chains in the case of a coating comprising the polymer alone (ITO/PPyC₅CO₂, curve 61).

After generation of the NiOₓ particles 111 (curve 62), the decrease 620 in this signal indicates that there is a disorganisation of the structure of the polymer 110. Nevertheless, it was expected in the case of the electro-generation of crystalline nanoparticles larger than 1 nm distributed in a structured manner to obtain a signal around 4 Å⁻¹ (621), which is not observed. This is in line with a polypyrrole composite material including sub-nanometric particles 111 of amorphous metal oxides distributed homogeneously but randomly without any apparent structure. Moreover, residual signals 611, 622 of ITO could be observed.

Having very small-size clusters with a large electroactive surface allows explaining, inter alia, the extremely high mass activity values measured by CV.

In general, the sub-nanometric architectures like the oxide particles may suffer from a lack of resistance and stability under electrocatalytic conditions. This has not been observed for the tested coatings 11, as described hereinbelow.

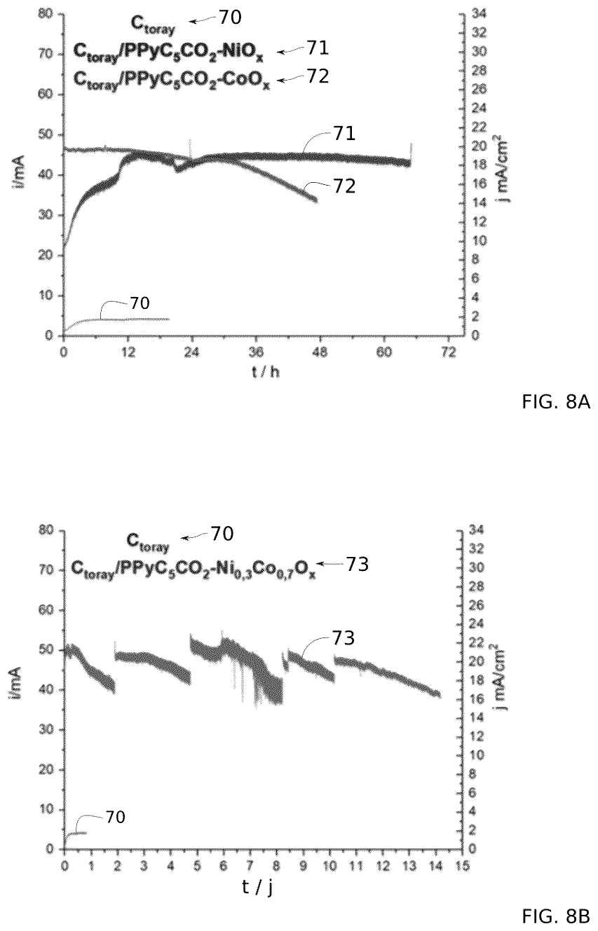

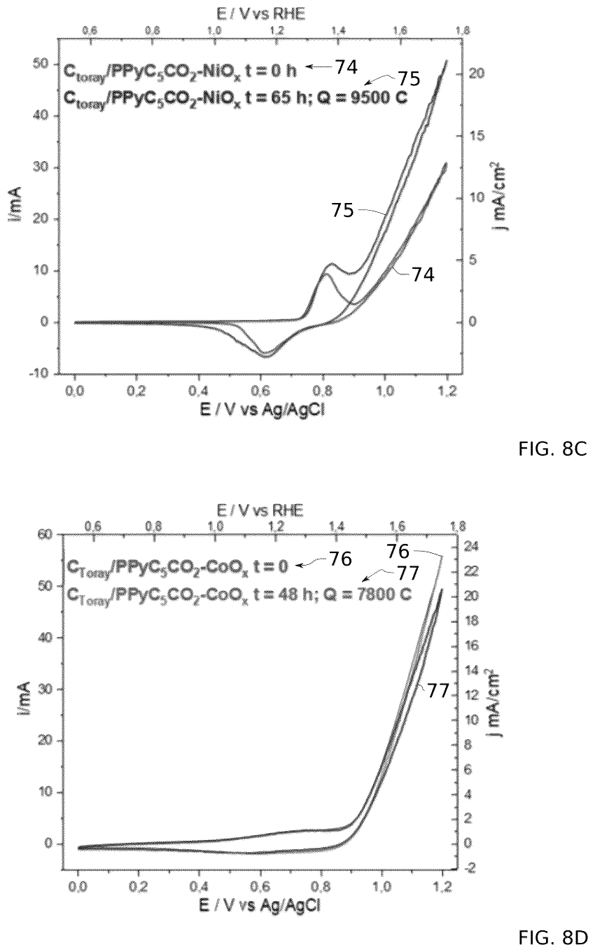

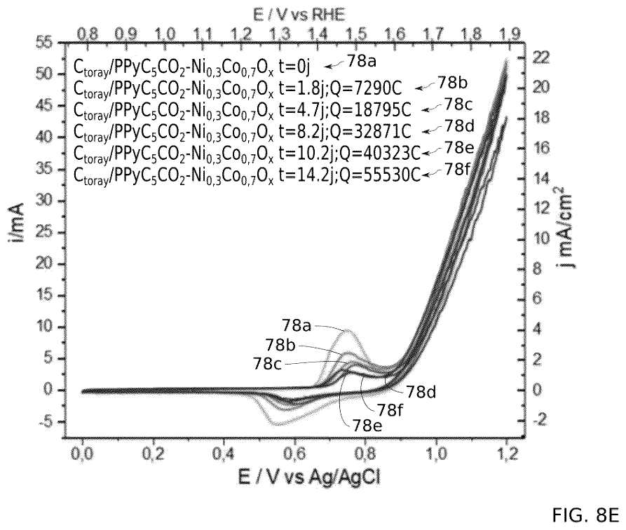

The stability of the coatings 11 is studied by the variation in the current density as a function of time at a given potential (1.2 V vs Ag/AgCl namely an overvoltage of 0.71 V) with respect to the oxidation of water at pH 9.2, as illustrated in FIGS. 8A (time t in hours) and 8B (time t in day), for:
70: an uncoated electrode C_{toray},
71: an electrode C_{toray}/PPyC₅CO₂—NiOₓ,
72: an electrode C_{toray}/PPyC₅CO₂—CoOₓ,
73: an electrode C_{toray}/PPyC₅CO₂—Ni_{0.3}Co_{0.7}Oₓ.

The electrocatalytic activity of the coatings 11 for the oxidation of water at pH 9.2 has also been measured over time, as illustrated in FIGS. 8C to 8E, for:
74: an electrode C_{toray}/PPyC₅CO₂—NiOₓ, at t=0 h,
75: the electrode C_{toray}/PPyC₅CO₂—NiOₓ, at t=65 h, with an electric charge amount of Q=9,500 C,
76: an electrode C_{toray}/PPyC₅CO₂—CoOₓ, at t=0 h,
77: the electrode C_{toray}/PPyC₅CO₂—COₓ, at t=48 h, with an electric charge amount of Q=7,800 C,
78a: an electrode C_{toray}/PPyC₅CO₂—Ni_{0.3}Co_{0.7}Oₓ, at t=0 h,
78b: the electrode C_{toray}/PPyC₅CO₂—Ni_{0.3}Co_{0.7}Oₓ, at t=1.8 days, with an electric charge amount of Q=7,290 C,
78c: the electrode C_{toray}/PPyC₅CO₂—Ni_{0.3}Co_{0.7}Oₓ, at t=4.7 days, with an electric charge amount of Q=18,795 C,
78d: the electrode C_{toray}/PPyC₅CO₂—Ni_{0.3}Co_{0.7}Oₓ, at t=8.2 days, with an electric charge amount of Q=32,871 C,
78e: the electrode C_{toray}/PPyC₅CO₂—Ni_{0.3}Co_{0.7}Oₓ, at t=10.2 days, with an electric charge amount of Q=40,323 C,
78f: the electrode C_{toray}/PPyC₅CO₂—Ni_{0.3}Co_{0.7}Oₓ, at t=14.2 days, with an electric charge amount of Q=55,530 C.

No significant loss of electrocatalytic activity has been observed over a time period of several days. Hence, the coating 11 has a very good stability over time, at least for the oxidation of water at pH 9.2. The observed variations are due to an acidification and a decrease in the volume of the solution in which the electrodes 1 are studied. A change of solution allows finding the initial activities. Observing the characteristic signals of the particles 111 throughout the electrolysis confirms the presence of these as the electrodes are used.

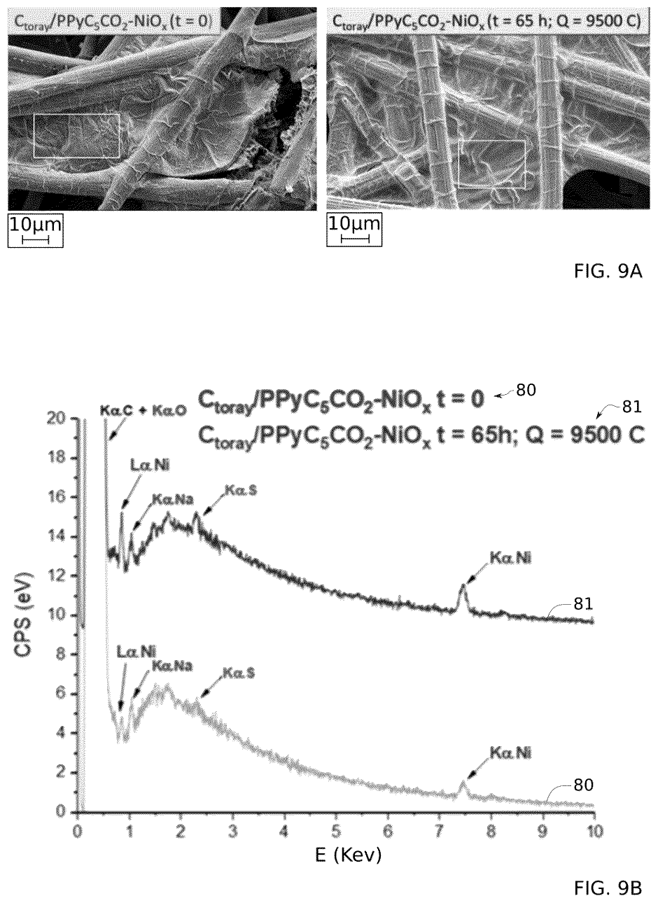

FIGS. 9A, 10A and 12A are SEM images allowing visualising the presence of the coating before and after electrolysis and therefore confirming its mechanical stability.

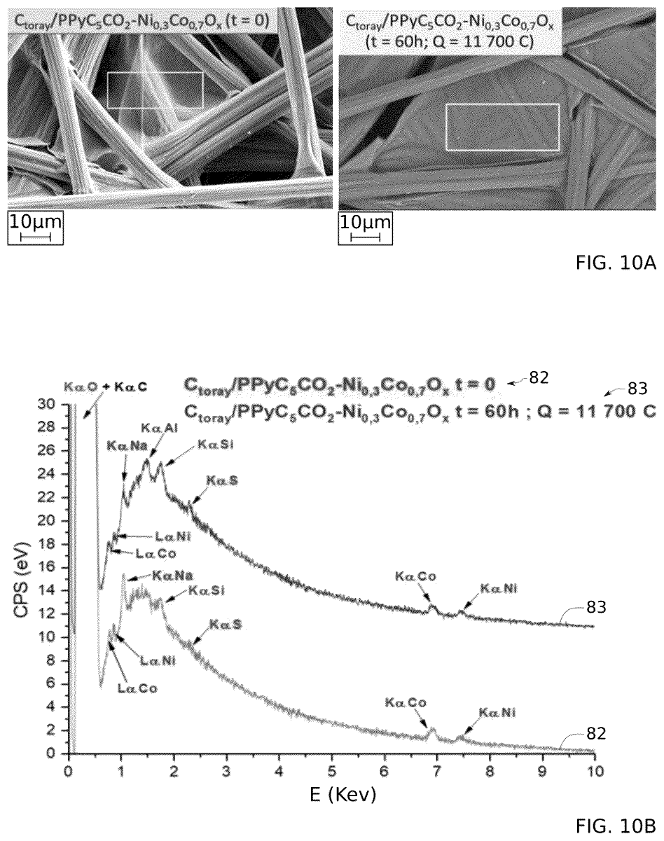

FIGS. 9B, 10B and 12B show EDX spectra allowing visualising the emission lines characteristic of each element detected in the window (white square) of the images of FIGS. 9A and 10A respectively. This allows confirming that the metal elements making up the oxide particles before and after electrolysis are actually found in the coatings. Hence, the capacity of the coating to stabilise the catalysts and prevent release thereof in solution during the catalysis is validated.

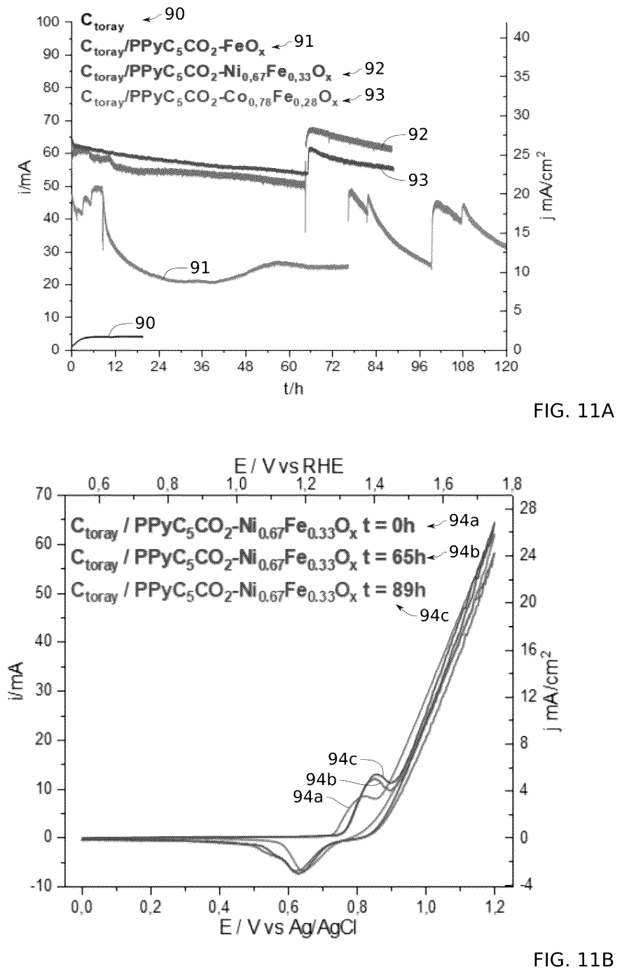

FIG. 11A illustrates the stability of the coatings 11, characterised by the study of the variation in the current density as a function of time t (in h) at a given potential (1.2 V vs Ag/AgCl is an overvoltage of 0.71 V) with respect to the oxidation of water at pH 9.2, for:
90: an uncoated electrode C_{toray},
91: a coated electrode C_{toray}/PpyC₅CO₂—FeOₓ,
92: a coated electrode C_{toray}/PpyC₅CO₂—Ni_{0.67}Fe_{0.33}Oₓ,
93: a coated electrode C_{toray}/PpyC₅CO₂—Co_{0.78}Fe_{0.28}Oₓ,

The electrocatalytic activity of the coatings 11 for the oxidation of water at pH 9.2 has also been measured over time for:
94a: a coated electrode C_{toray}/PpyC₅CO₂—Ni_{0.67}Fe_{0.33}Oₓ, at t=0 h
94b: the coated electrode C_{toray}/PpyC₅CO₂—Ni_{0.67}Fe_{0.33}Oₓ, at t=65 h
94c: the coated electrode C_{toray}/PpyC₅CO₂—Ni_{0.67}Fe_{0.33}Oₓ, at t=89 h.

No significant loss of activity has been observed over a time period of several days. The variations observed in the case of the iron-based alloys are due to an acidification and a decrease in the volume of the solution in which the electrodes are studied. Herein again, a change of solution allows finding the initial activities.

The rapid decrease in the activity of the electrodes with iron-based coatings is attributed to the formation of particles with less effective high degrees of oxidation. Performing a sweep at potentials between 0 and 1.2 V is enough to confer a high activity on our coatings. Again, observing the characteristic signals of the metal oxide particles 111 throughout the electrolysis confirms the presence of these.

All of these observations are both consistent with the presence of metal oxide particles 111 having a nanometric size, and more particularly a size smaller than 1 nm, and with the fact that the polymer-carboxylate matrix maintains their integrity during the catalysis by preventing corrosion thereof and aggregation thereof and by promoting self-repair, i.e. the reassembly of the particles 111 with compounds trapped in the polymer. If metal ions are released during the electrocatalysis, they would henceforth be complexed by the carboxylate groups of the polymer 110 so as to be transformed again into corresponding oxides. The voltammograms recorded after electrolysis are very close to the initial ones confirming the excellent stability of the electrode 1 and of its coating 11, with maintenance of the metal oxide particles 111 in the coating 11.

These results show that these composite coatings are very promising for controlling the formation, the size of the metal oxide catalysts and positively influencing their catalytic performances as well as their stabilities.

In view of the previous description, it clearly appears that the invention provides an improved electrode, in particular in terms of resources, environment and cost, while preserving a satisfactory electrocatalytic activity.

The invention is not limited to the previously-described embodiments and encompasses all of the embodiments covered by the invention. The present invention is not limited to the previously-described examples. Many other variants are possible, for example by combining previously-described features, without departing from the scope of the invention. Furthermore, the features described with regards to one aspect of the invention may be combined with another aspect of the invention. For example, the electrode may have any feature resulting from the implementation of the method and the method may include any step configured to reach a feature of the electrode.

1. An electrode comprising a body at least partially covered by a composite coating comprising:
a polypyrrole polymer or derivatives thereof comprising pyrrole monomer units having a side chain comprising at least one carboxylate group,
metal oxide particles based on at least one metal,
wherein the coating comprises an amount of the at least one metal of the metal oxide lower than or equal to 7 mmol/cm³ per carboxylate group of the pyrrole monomer units.

2. The electrode according to claim 1, wherein the metal oxide particles have at least one dimension smaller than or equal to 2 nm.

3. The electrode according to claim 1, wherein the metal oxide particles are based on at least two different metals.

4. The electrode according to claim 1, wherein the at least one metal of the metal oxide is selected from the group consisting of cobalt, nickel and iron.

5. The electrode according to claim 1, wherein the side chain of the pyrroles monomer units is linear.

6. The electrode according to claim 1, wherein the side chain comprises between 2 and 10 carbon atoms.

7. A method for manufacturing the electrode according to claim 1 comprising:
providing the body of the electrode,
electropolymerising over the body of the electrode a polymer comprising pyrrole monomer units having a side chain comprising at least one carboxylic acid group, so as to form a coating at least partially covering the body,
contacting the coating with a so-called “complexing” solution comprising at least one metal ion and one borate and/or phosphate buffer having a pH higher than or equal to 5.5, inducing a complexation of the at least one metal ion with at least one carboxylate group,
after contacting the coating with the complexing solution inducing the complexation of the at least one metal ion, rinsing the coating,
after rinsing the coating, electro-oxidising the complexed metal ions so as to form metal oxide particles.

8. The method according to claim 7, wherein the complexing solution comprises at least two different metal ions.

9. The method according to claim 7, wherein the complexing solution comprises a borate buffer having a pH higher than or equal to 6.

10. The method according to claim 7, wherein, upon contacting with the complexing solution, the temperature of the complexing solution is maintained at 30° C. by a temperature regulation device.

11. The method according to claim 7, wherein the coating is contacted with the complexing solution for at least 1 hour.

12. The method according to claim 7, wherein the electro-oxidation of the metal ions is done in a solution having a pH higher than or equal to 7.

13. The method according to claim 7, wherein the electro-oxidation of the metal ions is done in a solution comprising a borate buffer.

14. A method of electrocatalytic oxidation of water comprising the step of providing the electrode according to claim 1.

15. The electrode according to claim 2, wherein the metal oxide particles have at least one dimension smaller than or equal to 1 nm.

16. The electrode according to claim 6, wherein the side chain comprises 5 carbon atoms.

17. The method according to claim 9, wherein the complexing solution comprises a borate buffer having a pH higher than or equal to 7.2.

18. The method according to claim 11, wherein the coating is contacted with the complexing solution for at least 2 hours.

19. The method according to claim 12, wherein the electro-oxidation of the metal ions is done in a solution having a pH higher than or equal to 9.
